(19) United States
(12) Patent Application Publication
(10) Pub. No.: US 2012/0031512 A1
(43) Pub. Date: Feb. 9, 2012

(54) COMBINED PUMP AND FILTER MODULE

(76) Inventors: Gernot Hesse, Ohringen (DE); Achim Kress, Kupferzell (DE); Harald Kuhn, Neuenstadt a. Kocher (DE); Florian Müller, Mannhardt (DE); Albert Schick, Brackenheim (DE)

(21) Appl. No.: 13/204,047

(22) Filed: Aug. 5, 2011

(30) Foreign Application Priority Data
Aug. 7, 2010 (DE) 202010011160.9

(51) Int. Cl. F04B 53/20; F03D 11/00

(52) U.S. Cl. 137/544

(57) ABSTRACT

A pump and filter module for wind power plants may include a module housing having a receptacle for a pump and a filter device, wherein a plurality of associated lines may be integrated in the module housing.

The present invention relates to a combined pump and filter module, in particular for wind power plants.

Due to the variety of individual components in the filter and pump sector, mounting such individual components is usually relatively laborious, wherein in particular in case of a lubricant supply, a pump as well as a filter device are often arranged separately and in particular arranged in separate housings.

The present invention is concerned with the problem to simplify in particular mounting a filter device and a pump to adequate further components.

This problem is solved according to the invention by the subject matter of the independent claim 1. Advantageous embodiments are subject matter of the depending claims.

The present invention is based on the general idea to create a combined pump and filter module which is in particular used for wind power plants and which has a single, in particular one-piece module housing which has a receptacle for a pump and a filter device. Moreover, the associated lines, meaning in particular supply lines and discharge lines for the pump and the filter device, are also integrated in the module housing according to the invention. Thus, in case of the combined pump and filter module according to the invention, only one single module housing is available which has adequate receptacles for the pump and the filter device, whereby the mounting of such a combined pump and filter module, in particular to a wind power plant, can be significantly simplified. A particular advantage is the fact that due to the lines integrated in the module housing, a variety of sealing points, the lines themselves as well as further fastening elements can be eliminated, whereby not only the amount of components can be reduced, but at the same time, significant cost savings can be achieved during the production of the pump and filter module according to the invention. For example, the module housing can be made from aluminum, plastic or gray cast iron.

In an advantageous development of the solution according to the invention, the pump and filter module is configured for supplying a hub lubrication of a rotor of a wind power plant with lubricating oil. In this case, the pump and filter module thus serves for lubricating bearings of the rotor of a wind power plant, wherein it goes without saying that the pump and filter module according to the invention is not limited only to this use but can also be used for example in pressure systems such as, in particular, hydraulic systems. Besides a purely stationary use of the pump and filter module according to the invention, a mobile use is also conceivable, in particular in the form of a system mounted on a workshop trolley which can be driven for example to individual production machines to be serviced so as to carry out the cleaning of a respective fluid, for example hydraulic fluid or lubricating oil.

Advantageously, the pump and filter module has at least one valve device, in particular a bypass valve and/or a pressure control valve. This itemization which is mentioned only as an example shows already that in the pump and filter module according to the invention and in particular in the module housing of the same, additional components such as, for example, the mentioned valve devices can be integrated. Hereby, further mounting simplifications and in particular the reduction of sealing points can be achieved.

In a further advantageous embodiment of the solution according to the invention, the module housing is configured for receiving different pumps and/or for receiving different filter devices. This offers the great advantage that even for filter devices of different size, the same module housing can be used, wherein for connecting different filter devices to the module housing according to the invention, for example, adapter elements can be used. By such a configuration of the module housing, the same can be used in a broad and flexible manner, whereby cost savings can be achieved as well.

Further important features and advantages of the invention arise from the sub-claims, from the drawings, and from the associated description of the figures based on the drawings.

It is to be understood that the above mentioned features and the features yet to be explained hereinafter can be used not only in the respectively mentioned combination but also in other combinations or alone without departing from the context of the present invention.

Preferred exemplary embodiments of the invention are illustrated in the drawings and are explained in the following description in more detail, wherein identical reference numbers refer to identical, or similar, or functionally identical components.

In the figures, schematically:

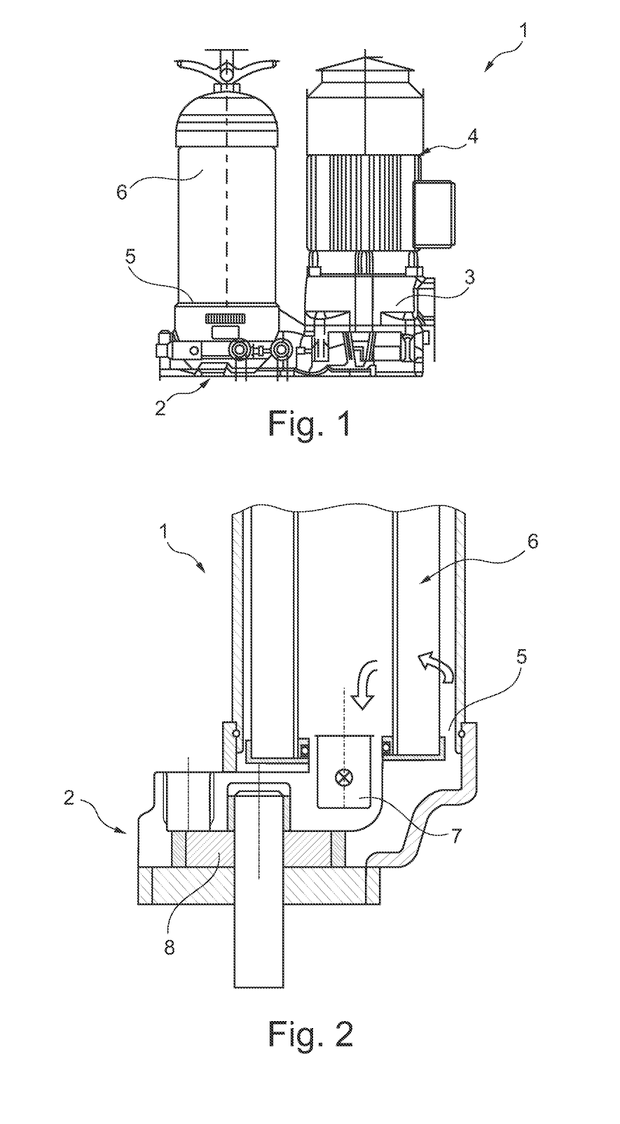

FIG. 1 shows a view of a possible embodiment of a pump and filter module according to the invention,

FIG. 2 shows a sectional view through a module housing of the pump and filter module.

According to FIG. 1, a combined pump and filter module 1 according to the invention has a module housing 2 which has a receptacle 3 for a pump 4 as well as a receptacle 5 for a filter device 6. For mounting the filter device 6 and the pump 4, therefore, only a single module housing 2 is required instead of two separate housings as previously needed, whereby installation expenditures as well as manufacturing costs can be reduced. Moreover, associated lines 7, preferably all supply and discharge lines for the pump 4 and the filter device 6 as well as potentially required valve devices are integrated in the module housing 2 according to the invention so that a complex external line configuration associated with occurring sealing problems can be avoided.

The pump and filter module 1 can be configured, for example, for supplying a hub lubrication of a rotor of a wind power plant and in this function, provides for supplying a bearing of the rotor of the wind power plant for example with lubricating oil. Likewise, the pump and filter module 1 can be used for hydraulic systems, wherein not only a stationary operation but, at the same time, a mobile operation of the pump and filter module 1 according to the invention is conceivable as well.

When viewing the FIG. 1, one can imagine that the pump 4 itself is not integrated in the module housing but only a rotor or a pump wheel 8 of the same (cf. also FIG. 2), wherein said pump wheel 8 is connected in a rotationally fixed manner to an electric motor of the pump 4. In addition, at least one valve device, for example in the form of a bypass valve and/or a pressure control valve can be integrated in the pump and filter module 1 according to the invention, in particular in the module housing 2, wherein the module housing 2 itself can be configured for example as plastic injection molded part or as a gray cast iron part. Besides the lines 7 integrated in the module housing 2, the module housing 2 can also have an inlet and an outlet for the fluid to be pumped or to be filtered and can be connected via said inlet and outlet to a fluid system. Likewise, it is conceivable that a thermal bypass valve is integrated in the module housing 2, that the pump and filter module 1 according to the invention can be connected, for example, to a cooler.

In a further advantageous embodiment of the solution according to the invention, the module housing 2 is configured for receiving pumps 4 of different sizes and/or filter devices 6 of different sizes. Hereby, the module housing 2 according to the invention can be used in a particularly flexible manner, wherein differently sized pumps 4 or differently sized filter devices 6 can be connected via suitable adapter elements. It goes without saying that the pump and filter module 1 shown according to FIGS. 1 and 2 is to be understood as an example only so that the pump 4 and the filter device 6 can be arranged on the module housing 2 not only parallel to each other, but for example also opposite each other or at an angle with respect to each other. In any case, with the pump and filter module 1 according to the invention, assembly expenses can be significantly reduced because the pump and filter module 1 can be prefabricated separately and, for example, is only mounted within the final assembly to further components such as, for example, a wind power plant or a hydraulic system. Moreover, a particular advantage is that the lines 7 can already be formed as an integral part of the module housing 2 and therefore do not have to be laid externally anymore in a complicated and expensive manner.

1. A pump and filter module for wind power plants, comprising: a module housing having a receptacle for a pump and a filter device, wherein a plurality of associated lines are integrated in the module housing.

2. The pump and filter module according to claim 1,
further comprising hub lubrication system for supplying a rotor of a wind power plant with lubricating oil.

3. The pump and filter module according to claim 1,
wherein the pump and filter module is included in a hydraulic system.

4. The pump and filter module according to claim 1,
further comprising at least one valve device.

5. The pump and filter module according to claim 1,
wherein the module housing is a plastic injection molded part.

6. The pump and filter module according to claim 1,
wherein the module housing defines an inlet and an outlet for fluid to be at least one of pumped and filtered.

7. The pump and filter module according to claim 1,
further comprising a thermal bypass valve being integrated into the module housing.

8. The pump and filter module according to claim 1,
wherein the module housing is configured for receiving at least one of pumps of difference sizes and filter devices of different sizes.

9. The pump and filter module according to claim 4, wherein the at least one valve device is at least one of a bypass valve and a pressure control valve.

10. The pump and filter module according to claim 2, wherein the pump and filter module is included in a hydraulic system.

11. The pump and filter module according to claim 10, further comprising at least one valve device.

12. The pump and filter module according to claim 11, wherein the module housing is a plastic injection molded part.

13. The pump and filter module according to claim 12, wherein the module housing defines an inlet and an outlet for fluid to be at least one of pumped and filtered.

14. The pump and filter module according to claim 13, further comprising a thermal bypass valve being integrated into the module housing.

15. The pump and filter module according to claim 14, wherein the module housing is configured for receiving at least one of pumps of difference sizes and filter devices of different sizes.

16. The pump and filter module according to claim 3, further comprising at least one valve device.

17. The pump and filter module according to claim 16, wherein the module housing is a plastic injection molded part.

18. The pump and filter module according to claim 17, wherein the module housing defines an inlet and an outlet for fluid to be at least one of pumped and filtered.

19. The pump and filter module according to claim 18, further comprising a thermal bypass valve being integrated into the module housing.

20. The pump and filter module according to claim 19, wherein the module housing is configured for receiving at least one of pumps of difference sizes and filter devices of different sizes.
